(19) United States
(12) Patent Application Publication
(10) Pub. No.: US 2025/0276251 A1
(43) Pub. Date: Sep. 4, 2025

(54) UNIQUE ANIMATRONIC ANIMATION

(71) Applicant: DISNEY ENTERPRISES, INC., Burbank, CA (US)

(72) Inventors: Brenton John Anderson, Kissimmee, FL (US); Ruben Jelle Grandia, Zürich (CH); Christian Gabriel Schumacher, Aarau (CH); Lars Espen Knoop, Birmensdorf (CH); Guirec G.H.F. Maloisel, Zürich (CH); Moritz Niklaus Bächer, Zürich (CH)

(21) Appl. No.: 18/594,559

(22) Filed: Mar. 4, 2024

(51) Int. Cl. A63G 31/00; G06T 13/40

(52) U.S. Cl. CPC A63G 31/00; G06T 13/40

(57) ABSTRACT

A method for generating an animation for an animatronic based on one or more creative requirements where the generated animation may imitate one or more input motions and is limited by the one or more creative requirements. The generated animation may then be retargeted onto the animatronic based on mechanical constraints, such that the animation is physically feasible on the animatronic. In some instances, the animation may be generated based on received animation source content performed by an actor that defines one or more input motions. The generation of the animation is done by, for example, a generative AI model, or by imitation learning. Additionally, the method may be performed in real-time. Associated systems and methods are also disclosed.

### FIELD

The present disclosure generally relates to systems and methods for the generation of animatronic animation.

### BACKGROUND

Amusement parks, theme parks, carnivals, arcades and various attractions of the sort use animatronics to produce a more interactive effect for guests in, for example, rides, shows, and games as the animatronic is intended to mimic the movement, look, and emotion of characters sharing the theme of the rides, shows and games. In such cases, animatronics use a predetermined/set animation with a set script that is repeated by the animatronic each time the attraction is experienced. For example, in an attraction ride an animatronic uses a “surprise” animation, where the animatronic jumps out of a hidden place and scares a rider with a corresponding loud programmed voice line each time the attraction ride is experienced.

In the case that a person wants to experience an attraction more than once, the static animation for the animatronic creates a repetitive and less-enjoyable ride for the person. For example, returning to the example attraction ride, a guest riding the attraction ride a second time will experience a diminishing effect from the ride as they have already experienced the scaring effect of the same “surprise” animation. Due to the repetitive nature of the programmed animation, the guest may not return to the attraction more than once or may be dissatisfied with their second and further consecutive experiences with the animatronic in the attraction.

### SUMMARY

According to various examples, a method for generating animatronic animation is provided. The method may include generating an animation for an animatronic based on one or more creative requirements, the animation imitating one or more input motions and limited by the one or more creative requirements. The method may include retargeting the animation onto the animatronic based on mechanical constraints of the animatronic, such that the animation is physically feasible on the animatronic. The method may include outputting the animation to the animatronic.

In some examples, the method may include receiving animation source content for the animation, wherein the animation source content defines the one or more input motions. In some examples, the generating may include generating the animation using a trained model. The trained model may be based on imitation learning or generative artificial intelligence. In some examples, the one or more creative requirements may include a music timing requirement, a facial requirement, or an artistic requirement. In some examples, the mechanical constraints may include physical limitations of the animatronic itself. In some examples, a system configured to perform the method may be provided, the system including the animatronic. The method may be performed on the animatronic in real-time.

According to various examples, a method for animatronic animation generation is provided. The method may include receiving animation source content. The method may include generating an animation for an animatronic based on the animation source content and based on at least one first constraint or requirement. The method may include retargeting the animation onto the animatronic based on at least one second constraint or requirement. The method may include outputting the animation to the animatronic.

In some examples, the receiving may include receiving a motion capture dataset of one more motions performed by an actor. In some examples, the receiving may include receiving existing animation performed by the animatronic or another animatronic. In some examples, the animation may be generated to imitate or match the animation source content irrespective of kinematic constraints of the animatronic. The retargeting may include determining motions of the animatronic based on the kinematic constraints. In some examples, the animation may be a first animation. The method may include generating a second animation for the animatronic based on the animation source content and based on the at least one first constraint or requirement, wherein the second animation is different than the first animation. The method may include retargeting the second animation onto the animatronic based on the at least one second constraint or requirement. In some examples, the at least one first constraint or requirement may include a creative requirement defined by existing music, lighting, or narration. In some examples, the at least one second constraint or requirement may include a kinematic constraint of the animatronic.

According to various examples, a method for generating new animations for an animatronic is provided. The method may include receiving animation source content defining input motions. The method may include generating an animation similar to the input motions and based on at least one creative requirement for the animation. The method may include retargeting the animation onto the animatronic based on at least one kinematic or dynamic constraint of the animatronic. The method may include deploying the animation to the animatronic for performance by the animatronic.

In some examples, the retargeting may include transferring the animation onto the animatronic using an inverse kinematics and/or inverse dynamics tool. The inverse kinematics and/or inverse dynamics tool may validate the animation against all physical constraints of the animatronic. In some examples, the method may include receiving an operator command approving the animation. In some examples, the input motions may be created by a human or robot actor.

According to various examples, a method for training a model used to generate animations for an animatronic is provided. The method may include receiving a set of constraints of an animatronic and a set of motion data. The method may include training a model based on the set of motion data and the set of constraints to generate an animation that is physically feasible on an animatronic.

In some examples, the motion data may include a set of input motions that is performed or has been previously performed by an actor. The training may include analyzing kinematic inputs of the input motions. The training may include simulating, based on the analysis, kinematic and dynamic motion of the animatronic. The training may include determining whether the kinematic and dynamic motion is feasible on the animatronic, wherein feasibility is defined as being within the set of constraints. The training may include repeating the simulation with one or more adjustments to the kinematic or dynamic motion based on the determination. The actor may be a human actor, the animatronic, or a second animatronic. In some examples, the training may include learning an encoder and a decoder for the set of motion data. In some examples, the set of constraints may include at least one of a kinematic constraint, a dynamic constraint or a creative requirement.

### BRIEF DESCRIPTION OF THE DRAWINGS

FIG. 1 illustrates an example of a system used in the generation of unique animations for an animatronic, according to embodiments herein.

FIG. 2 illustrates a functional block diagram of an animatronic design system, according to embodiments herein.

FIG. 3 illustrates an example computing system used for implementing various embodiments in the examples described herein.

FIG. 4 illustrates a flowchart of a method for generating animatronic animation, according to embodiments herein.

FIG. 5 illustrates a flowchart of a method for animatronic animation generation, according to embodiments herein.

FIG. 6 illustrates a flowchart of a method for generating new animations for an animatronic, according to embodiments herein.

FIG. 7 illustrates a flowchart of a method for training a model used to generate animations for an animatronic, according to embodiments herein.

### SPECIFICATION

The present disclosure provides various systems and methods for generating new and unique animations for animatronics. It should be understood that the term “animation” as used herein is meant to encompass any programmed movement or motion performed by an animatronic to mimic or imitate a character or subject (and their corresponding motion) within an attraction including, for example, animatronic body movement, animatronic appendage movement, animatronic mouth movement, or other programmed movement made by the animatronic. It should also be understood that the term “animatronic” as used herein is meant to encompass any robot, robot actor, mechanical system or programmable platform that is intended to move (e.g., perform an animation), output a sound, or produce a desired effect, such as when being interacted with (e.g., during an attraction, ride, show or any form of entertainment (from now referred to as “attraction”)).

In some embodiments, the present disclosure leverages the use of a model, which may be in the form of a machine learned model, a generative artificial intelligence model (e.g., checking if a generated animation is similar as compared to an input animation), an imitation learning model (e.g., with simulation and feedback), or any other similar technologies, to generate a unique animation for an animatronic. The generated animation may be a new animation that has not been repetitively performed by the animatronic. The generated animation may adhere to both creative requirements of the desired creative effect of the attraction, and mechanical constraints of the animatronic and attraction. For example, the generated animation, while new and unique compared to previous animations, may hold true to the spirit (e.g., the creative elements or theme) of existing animatronics (e.g., audio-animatronics) and of the attraction itself. Additionally, or alternatively, the generated animation may be mechanically feasible as defined by one or more mechanical or physical constraints of the animatronic and/or attraction. The model is trained on, for example, a received set of input motions that is performed or has been previously performed by an actor or secondary animatronic as to generate unique animations that are similar to existing animations/motions and on received creative and mechanical constraints. Note that, in some examples, the received creative requirements and physical constraints can be used as inputs to the model in place of the model being trained on the requirements and constraints.

In the case that the model is an imitation learning model, to train the model, the model first learns an animation by analyzing kinematic inputs of an animation that is performed (e.g., imitating previous animations used by the animatronic). Then, the imitation learning model simulates kinematic motion that the animatronic can perform, based on the analysis, and the simulator informs the model that the animation is either feasible or not feasible. The simulation is repeated with an animation generated by the imitation learning model, such as with tweaks to the animation at each repetition, so that the final generated animation is feasible. It should be understood that feasibility encompasses the generated animation being within the constraints and parameters of the animatronic, the desired effect that the animation should have in the attraction, the generated animation being smooth and realistic as decided by the model or by an artist or engineer who reviews and validates the generated animation, or any combination thereof.

In the case where the model is a generative model, to train the model, the model may take an input set of motion data and use/learn an encoder and a decoder for the motion data (e.g., at the same time) to generate an animation. The motion data may be performed or may have already been performed by an actor or a secondary animatronic. The encoder may compress the motion to a lower dimensional space of animation (e.g., latent space) and the decoder may process the generated animation that exists in a lower dimensional space into a kinematic space for the animatronic to use. The latent space/lower dimensional space of animation may help the model to better align the generated animation with various inputs and constraints/parameters of the animatronic and the desired effect of the animation given to the model.

It should be understood that, in some embodiments, a combination of an imitation learning model and a generative model is trained and used to generate unique animations. For example, an imitation learning model can generate the motion data used for the generation of animations by the generative model. In another example, the generative model can generate motion data to enhance imitation learning model use cases.

The generated animation may be similar to previous animations with adjustments, tweaks or other changes in movement, emotions, and other motion, while still being applicable to the attraction and/or emotion of the attraction. For example, the animatronic may output the same voice line in a show, or may induce the same effect/emotion in a ride, while having unique motions and facial expressions each time an attraction is experienced (e.g., for each subsequent visit) with the attraction.

In some instances, the model used to generate the animation takes into consideration various parameters and/or constraints that the animatronic adheres to when performing the animation. For example, this may include physical/mechanical constraints of the animatronic itself (e.g., how far the animatronic can move and/or twist), a creative requirement (e.g., the desired mood and effect of an attraction), a musical requirement (e.g., a certain beat or sounds in a song that the animatronic is to move or produce a voice line at), a facial requirement or an artistic requirement stemming from the story and/or experience that the animatronic is intended to produce. Additionally or alternatively, previous animations used by the animatronic (e.g., animation source content) created by artists or engineers may be taken into account by the model so that the generated animation is within the constraints of the animatronic and artistically applicable for the desired effect of the attraction that the animatronic is in. It should be noted that the creative requirements, mechanical constraints, and previously performed animations can be used as either inputs to the model or as training data that the model is trained on.

In some instances, the generated animation may not incorporate all constraints of the animatronic, in which case a retargeting step may be used to remedy this. Retargeting may be performed using an inverse dynamics tool. The inverse dynamics tool may ensure or guarantee that the animation (e.g., the motion of animation) can be performed by the animatronic and is not limited by or is violating physical constraints or mechanical constraints. The retargeting of the generated animation onto the animatronic can be done offline or dynamically in real time. In the case that the retargeting is completed offline, the generated animation can be chosen from a larger pool of generated animations, reviewed and retargeted onto the animatronic. The generated animation may be stored on the animatronic itself. In the case that the retargeting is completed in real time (e.g., in an online version), the generated animation is not stored on the animatronic but rather is retargeted onto the animatronic dynamically, in real-time. Further, an inverse dynamics tool may retarget the generated animation such that the motion adheres to creative requirements and mechanical constraints in real time. In some cases, for real-time use, generated animations may be generated and processed simultaneously for a short horizon of time. The output of the inverse dynamics tool may be sent to a real-time control system directly within the animatronic. Additionally or alternatively, a generated animation may be selected from a pool of one or more generated animations in, for example, offline processing, by an artist or in real time by a processor or model to be retargeted on the animatronic, where the selected generated animation best adheres to the creative requirements and mechanical constraints.

Optionally, in some embodiments, the generated animation is reviewed and validated by an artist or engineer so that the animation is within the physical/mechanical constraints (e.g., velocity, position, or torque limits) of the animatronic onto which the animation is being retargeted and is applicable to the story or produces the intended effect desired for the attraction in which the animatronic is positioned or placed. During this review, for example, the artist may tweak the generated animation as to create a smoother animation for the animatronic or add a specific motion or pauses for intended story beats to highlight certain parts of the attraction. In another example, a secondary model or computer process may review the animation and add smoothing to the animation to make the animatronic more realistic and/or applicable to the desired artistic effect of the attraction.

In some embodiments, the model to generate unique animations can use a motion capture set (e.g., animation source content) as an input or is trained on the motion capture set, to generate the animation for the animatronic. For example, the motion capture set is a set of movements performed by either an existing animatronic or a human that is captured where the input motions of the animatronic and/or human is transferred into input motions for an animatronic system. The motion capture set is used to generate input data for the model, thus allowing the generated animation to be more varied in comparison to the already performed animation by the animatronic.

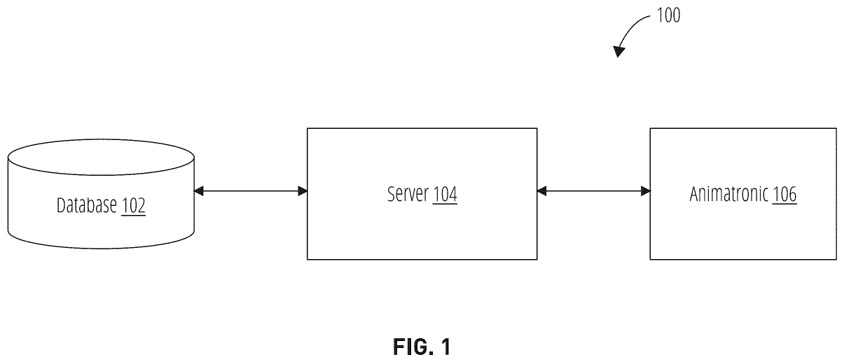

Turning now to the figures, FIG. 1 illustrates an example of a system 100 used in the generation of unique animations for an animatronic. The system 100 generally comprises a database 102 used to store constraints and parameters for an animation, a server 104 storing a model used to generate an animation, and an animatronic 106 that performs the generated animation. As can be appreciated, the model for animation generation may be hosted on one or more servers, computers, and/or locations, and the example shown in FIG. 1 is illustrative. Similarly, although a single animatronic is shown, in many instances, there may be multiple animatronics 106 in communication with the server 104.

The database 102 stores parameters and constraints as well as animation source content used for generation of unique animations. For example, the database 102 stores parameters and constraints relating to creative requirements, musical timing requirements, facial requirements and artistic requirements. The creative requirements and other artistic requirements of the like include, for example, a desired mood or theme of the attraction, the duration of the attraction cycle so that the animatronic stays within the creative timeline, and/or audio and show beats (e.g., facial animations or spoken audio) to ensure the animatronic stays on pace with the attraction/show and does not deviate from creative timing.

Additionally, the database 102 stores mechanical constraints that the animatronic 106 cannot deviate from if it is to perform the generated animation. For example, mechanical constraints can include how far the animatronic 106 can twist, how fast the animatronic 106 can move, what limbs/appendages the animatronic 106 can move, and other limits such as actuator torque or velocity limits. In some instances, the physical/mechanical constraints include constraints of the environment around the animatronic 106 such as how far the animatronic 106 can move/twist itself or its limbs and appendages in order to avoid collisions with the environment or with itself. It should be understood that examples discussed herein of physical/mechanical constraints is not an exhaustive list and the physical/mechanical constraints can encompass various constraints that should be adhered to for smooth operation of any animatronic 106. Further, the mechanical constraints can be used in review and validation of the generated animation as to ensure that the animatronic can perform the animation.

In some cases, the database 102 can store animation source content encompassing animations previously created by artists/engineers and possibly already performed by the animatronic 106. This animation source content may be used in the generation of animations as it provides a clear outline of an animation that adheres to creative requirements and physical/mechanical constraints while having the desired effect and/or experience for the attraction that the animatronic 106 is in. The database 102 transmits the constraints, parameters and animation source content discussed herein to the server 104 for use in the generation of unique animations. However, in some cases, the database 102 may also receive constraints, parameters, and generated animations, from the server 104, to store for use in future animation generation.

The server 104 stores a model (or any other computer process or program of the sort) used for generating a unique animation and completes processing of the generated animation or review of the generated animation. For example, the model uses the constraints, parameters and source animation content, received from the database 102, to generate a unique animation for an animatronic 106 with a the same desired effect and experience for an attraction that is still within the received constraints, as discussed herein. However, in some examples, the generated animation may include motion that is not necessarily dynamically possible for the animatronic 106, but is unique and can be, in some cases, reviewed, processed and validated to be applicable to the animatronic before being retargeted onto the animatronic 106. The generated animation is unique from previously generated animations as to create a new and fresh interaction for a guest in a subsequent (e.g., each) experience with the animatronic 106 or the attraction, while still adhering to the creative requirements and mechanical constraints. In some instances, the model used at the server 104 to generate the unique animation is an imitation learning model and in other instances, the model used at the server 104 is a generative artificial intelligence model. It should be understood that more than one unique animation can be generated by the model and the set of generated animations can be transmitted to the animatronic 106 for retargeting onto the animatronic 106.

Optionally, in some instances, the generated animation (or set of generated animations) is reviewed and/or validated by an artist or an engineer, at the server 104, to make sure the animation is smooth, dynamically possible, and hitting all creative cues to produce the desired effect when experiencing the animatronic 106. The server 104 then transmits the generated animation to the animatronic 106.

The animatronic 106 receives, from the server 104, the generated animation (or set of generated animations). Then, the generated animation may be retargeted onto the animatronic 106 using inverse kinematic/dynamics tools as discussed herein and performs the generated animation. The animatronic 106 may also run analysis on the generated animation to guarantee that the generated animation can be performed by the animatronic 106 and will not violate any constraints and is mechanically feasible. In some cases, the retargeting of the animation onto the animatronic 106 can be done offline. In such cases, the generated animation can be stored on the animatronic 106 itself before being performed. In the case that the animatronic 106 stores the generated animation, one animation may be selected to be performed by the animatronic 106 as one or more, or a set of generated animations may be stored by the animatronic 106. In some other cases, the animation is not stored by the animatronic 106 and the retargeting is dynamically done in real time when the generated animation is received by the animatronic 106. Additionally, the animatronic 106 can transmit any animation that it has stored or has previously performed to the server 104 for use in generation of new animations.

It may be noted that, in some embodiments, the communication between the database 102, the server 104, and the animatronic 106, and the generation of the animation is done in real time.

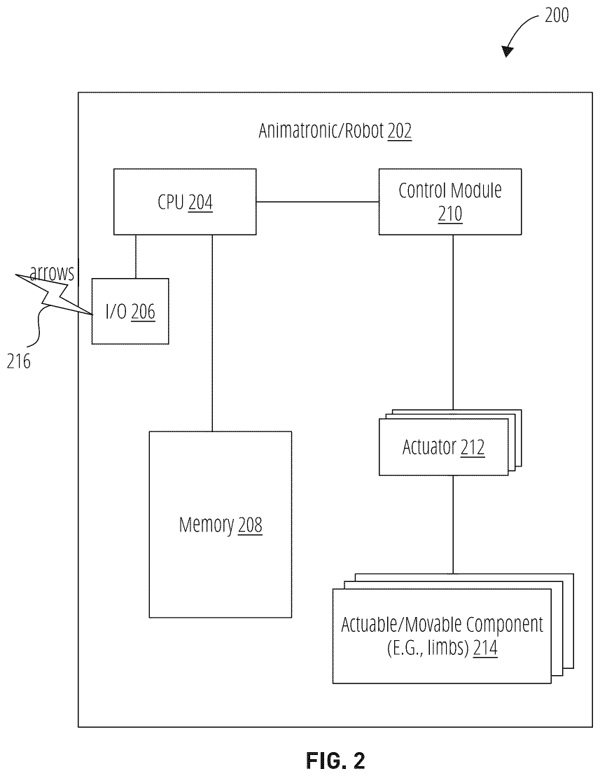

FIG. 2 illustrates a functional block diagram of an animatronic design system 200 of an animatronic, or robot 202 (e.g., animatronic 106) that can be operated and/or controlled according to the generated animation discussed herein. For example, the generated animation would provide movements of a character's story or intended effect of an attraction. Then, the movements (and artistic characteristics) are loaded into an already existing animatronic, or robot, 202, as shown, in a wired or wireless manner with arrows 216. After loading, the animatronic 202 becomes an actor with the data and pseudo-intelligence to perform a role, executing a performance which can include motions, audio, and the like.

The animatronic 202 may take a wide variety of forms to practice the generated animation. Generally, the animatronic 202 will include a pelvis, a torso, and a head, but these are not required. Further, the animatronic will include a plurality of actuators 212 (or drivers) that are selectively operated by a control module 210 to actuate or drive one or more actuable/movable components 214 such as one or more limbs with (or without) feet, one (or more) arms with (or without) hands, and so on. Examples generally encompass animations for a two-legged animatronic meant to enhance attractions, but this is not a limitation as the concepts are equally applicable to other movable components of an animatronic.

The animatronic 202 includes a processor 204 (e.g., CPU) managing operations of I/O 206 devices, which are used at least to receive communications such as from a design station, which may be an ordinary PC workstation, laptop, or the like using software tools described in the following paragraphs. Particularly, the animatronic 202 also includes memory 208 or data storage devices for storing the animation received from, for example, a server (e.g., server 104) or computer where the animation is generated and/or stored.

The processor 204 runs software and/or executes code/instructions (e.g., in memory 208) to provide the functionality of a control module 210. The control module 210 may be configured to include one or more artificial intelligence (AI) components and to otherwise adapt to current conditions for the animatronic. For example, the control module 210 may operate to determine a present mood of the animatronic 202 (such as afraid, sad, or happy), and the control module 210 may then control the animatronic 202 (e.g., via control signals to the actuators 212) based on the motions in the generated animation.

Motion blending of control module 210 may be configured to generate reasonable transition actions between the actions (or positions) defined in the generated animations so that every possible movement/action of the animatronic 202 does not have to be predefined. The AI of the control module 210 also acts to keep the animatronic 202 within the nature of the character even when not animated (not performing a movement), and this may include staying “alive” or in the moment (e.g., by retaining the expected body language). As can be seen from FIG. 2, the animatronic 202 is controlled using a set of actions as defined by the generated animation to perform a gesture or movement in a manner that is defined for a particular character, which provokes emotion and/or belief of life in a human observer of the animatronic 202.

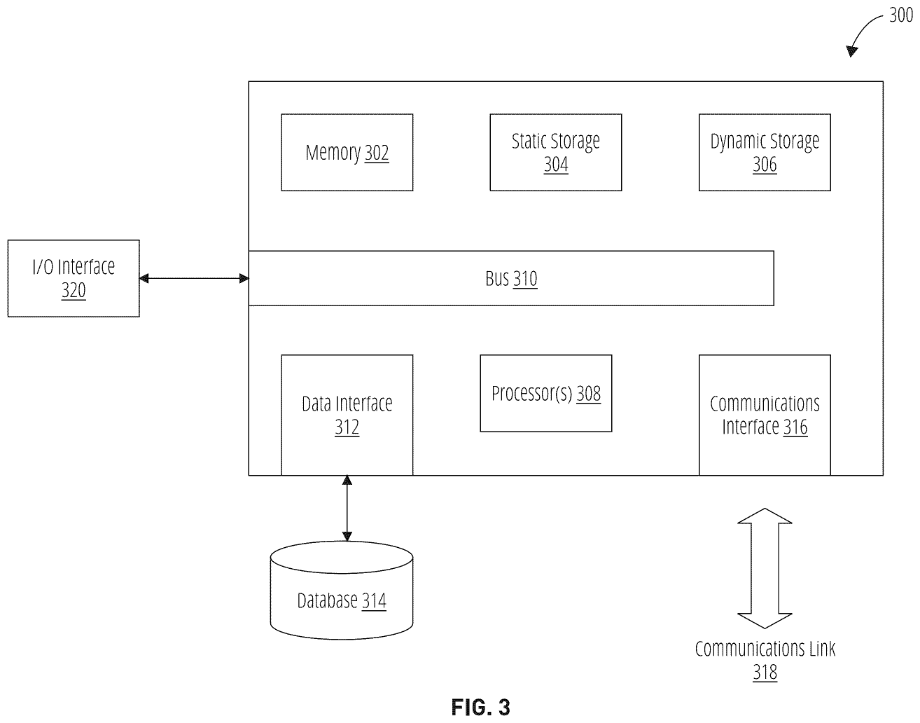

FIG. 3 illustrates an example computing system 300 used for implementing various embodiments in the examples described herein. For example, in various examples, the database 102, the server 104 and/or the animatronic 106 are implemented by one or several computing systems 300. This disclosure contemplates any suitable number of computing systems 300. For example, the computing system 300 is a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 300 includes one or more computing systems; is unitary or distributed; spans multiple locations; spans multiple locations; spans multiple machines; spans multiple data centers; or resides in a cloud, which includes one or more cloud components in one or more networks.

Computing system 300 includes a bus 310 (e.g., an address bus and a data bus) or other communication mechanism for communicating information, which interconnects subsystems and devices, such as processor 308, memory 302 (e.g., RAM), static storage 304 (e.g., ROM), dynamic storage 306 (e.g., magnetic or optical), communications interface 316 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 320 (e.g., keyboard, keypad, mouse, microphone). In particular embodiments, the computing system 300 includes one or more of any such components.

In particular embodiments, processor 308 includes hardware for executing instructions, such as those making up a computer program. For example, a processor 308 executes instructions for the generation of animations at the server 104. The processor 308 circuity includes circuitry for performing various processing functions, such as executing specific software for perform specific calculations or tasks. In particular embodiments, I/O interface 320 includes hardware, software, or both, providing one or more interfaces for communication between computing system 300 and one or more I/O devices. Computing system 300 includes one or more of these I/O devices, where appropriate. One or more of these I/O devices enable communication between a person and computing system 300.

In particular embodiments, the communications interface 316 includes hardware, software, or both providing one or more interfaces for communication (such as, for example, packet-based communication) between computing system 300 and one or more other computer systems or one or more networks. One or more memory buses (which can each include an address bus and a data bus) couple processor 308 to memory 302. Bus 310 includes one or more memory buses, as described below. In particular embodiments, one or more memory management units (MMUs) reside between processor 308 and memory 302 and facilitate accesses to memory 302 requested by processor 308. In particular embodiments, bus 310 includes hardware, software, or both coupling components of computing system 300 to each other.

According to particular embodiments, computing system 300 performs specific operations by processor 308 executing one or more sequences of one or more instructions contained in memory 302. For example, instructions for generating in the animation is contained in memory 302 and is executed by the processor 308. Such instructions are read into memory 302 from another computer readable/usable medium, such as static storage 304 or dynamic storage 306. In alternative embodiments, hard-wired circuitry is used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 308 for execution. Such a medium takes many forms, including but not limited to, nonvolatile media and volatile media. Non-volatile media includes, for example, optical or magnetic disks, such as static storage 304 or dynamic storage 306. Volatile media includes dynamic memory, such as memory 302.

Computing system 300 transmits and receives messages, data, and instructions, including program, e.g., application code, through communications link 318 and communications interface 316. Received program code is executed by processor 308 as it is received, and/or stored in static storage 304 or dynamic storage 306, or other storage for later execution. A database 314 is used to store data accessible by the computing system 300 by way of data interface 312. For example, parameters, constraints, and past used animations are stored using a database 314. In various examples, communications link 318 communicates with the database 102, the server 104, and/or the animatronic 106.

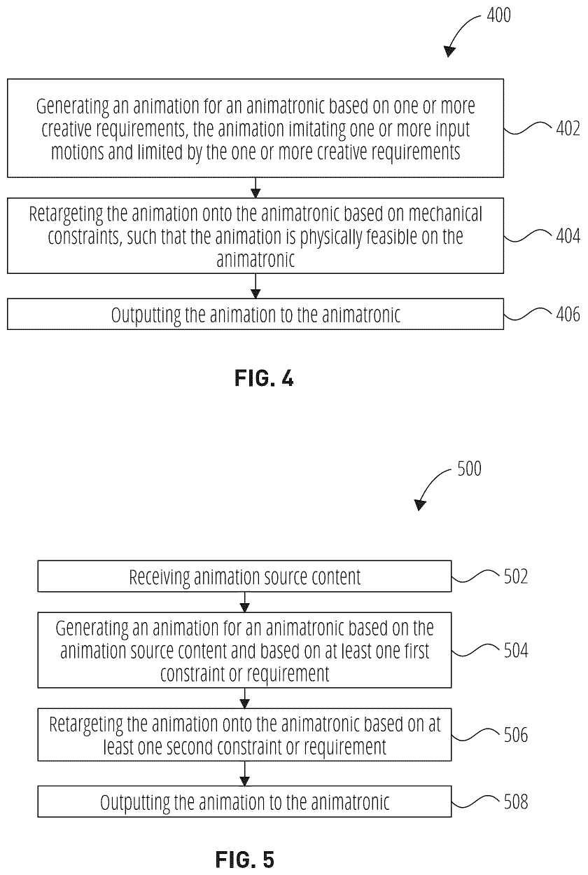

FIG. 4 illustrates a flowchart of a method 400 for generating animatronic animation according to embodiments herein. The method 400 may be performed by system 100, animatronic design system 200, or computing system 300, described above, or components thereof. At block 402, the method 400 includes generating an animation for an animatronic based on one or more creative requirements. The animation may imitate one or more input motions and may be limited by the one or more creative requirements. For example, the creative requirements may include a music timing requirement, a facial requirement, or an artistic requirement. Other possible constraints include mechanical constraints used so that the animation is physically feasible to be performed by the animatronic. Additionally or alternatively, the animation may be generated based on an animation source content that defines one or more input motions. In some embodiments, the generating comprises generating the animation using a trained model where the trained model is based on, for example, imitation learning or generative artificial intelligence.

At block 404, the method 400 further includes retargeting the animation onto the animatronic based on mechanical constraints of the animatronic, such that the animation is physically feasible on the animatronic. The mechanical constraints may include physical limitations of the animatronic itself, such as kinematic constraints and/or dynamic constraints of the animatronic. In some cases, the method 400 can be performed on the animatronic in real-time with the animation not being stored by the animatronic. In some other cases, the method 400 can be performed on the animatronic offline and the generated animation is stored on the animatronic itself. The retargeting of the animation onto the animatronic includes using inverse kinematics and/or inverse dynamics tools that can guarantee that the animation can be ran on the animatronic.

At block 406, the method 400 further includes outputting the animation to the animatronic. In some instances, outputting the animation to the animatronic may occur in real time and, in other instances, the animatronic may store the outputted animation.

FIG. 5 illustrates a flowchart of a method 500 for generating animatronic animation according to embodiments herein. The method 500 may be performed by system 100, animatronic design system 200, or computing system 300, described above, or components thereof. At block 502, the method 500 includes receiving animation source content. For example, the animation source content includes motion capture dataset as performed by actor or a previous existing animation performed by an animatronic or a second animatronic.

At block 504, the method 500 further includes generating an animation for an animatronic based on the animation source content and based on at least one first constraint or requirement. For example, the animation is generated to imitate or match the animation source content irrespective of kinematic limitations of the animatronic, and the retargeting comprises determining motions of the animatronic based on the kinematic constraints. In some cases, the first constraint includes a creative requirement defined by existing music, lighting, or narration. Additionally, a second animation may be generated for the animatronic based on the animation source content and based on the at least one first constraint or requirement, wherein the second animation is different than the first animation.

At block 506, the method 500 further includes retargeting the animation onto the animatronic based on at least one second constraint or requirement. For example, the second constraint includes a kinematic constraint of the animatronic. In some cases, the second generated animation is retargeted onto the animatronic based at least the second constraint or requirement.

At block 508, the method 500 further includes outputting the animation to the animatronic. In some instances, outputting the animation to the animatronic may occur in real time and, in other instances, the animatronic may store the outputted animation.

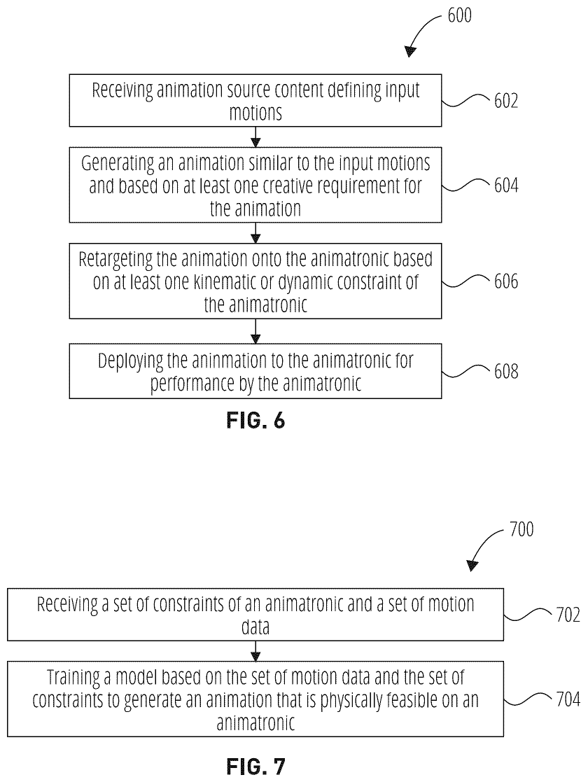

FIG. 6 illustrates a flowchart of a method 600 for generating new animations for an animatronic, according to embodiments herein. The method 600 may be performed by system 100, animatronic design system 200, or computing system 300, described above, or components thereof. At block 602, the method 600 includes receiving animation source content defining input motions. The input motions may be created by a human or a robot actor, as described herein. For example, the animation source content includes performed motions by an actor or previous animations performed by the animatronic or a second, different, animatronic.

At block 604, the method 600 further includes generating an animation similar to the input motions and based on at least one creative requirement (or constraint) for the animation. In some instances, the creative requirements are defined by existing music, lighting, or narration and are used in generation so that the generated animation produces the desired effect or experience with the attraction. Accordingly, to determine that the animation produces the desired effect an artist or engineer may review and validate the generated animation and, if the desired effect is produced, may transmit an operator command approving the animation.

At block 606, the method 600 further includes retargeting the animation onto the animatronic based on at least one kinematic or dynamic constraint of the animatronic. For example, retargeting includes transferring the animation onto the animatronic by using an inverse kinematics and/or inverse dynamics tool. It should be understood that, in some cases, the inverse kinematics and/or inverse dynamics tool validates the generated animation against physical constraints of the animatronic. The physical constraints may include kinematic constraints and/or dynamic constraints, such as the range of movement or change the system can undergo (e.g., how far the animatronic can move or twist), actuator torque or velocity limits, or how the system will move under given conditions (e.g., how/if the animatronics' appendages move). The physical constraints may also be used as an input with the creative requirements for the generation of the animation.

At block 608, the method 600 further includes deploying the animation to the animatronic for performance by the animatronic. In some cases, the deployment may occur in real time or, in other cases, the animatronic may store the deployed animation.

FIG. 7 illustrates a flowchart of a method 700 for training a model used to generate animations for an animatronic, according to embodiments herein. The method 700 may be performed by system 100, animatronic design system 200, or computing system 300, described above, or components thereof. At block 702, the method 700 includes receiving a set of constraints of an animatronic and a set of motion data. In some instances, the motion data includes a set of input motions that is performed or has been previously performed. Further, the input motions may be performed by a human actor, the animatronic, or a second animatronic.

At block 704, the method 700 further includes training a model based on the set of motion data and the set of constraints to generate an animation that is physically feasible on an animatronic. For example, the constraints include a kinematic constraint, a dynamic constraint, and/or a creative requirement. In some instances, the training includes analyzing kinematic inputs of the input motions, simulating, based on the analysis, kinematic and dynamic motion of the animatronic, and determining whether the kinematic and dynamic motion is feasible on the animatronic where feasibility is defined as being within the set of constraints. Further, the training may include repeating simulations with one or more adjustments to the kinematic motion based on the determination. Additionally or alternatively, the training may include learning an encoder and a decoder for the set of motion data.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method for generating animatronic animation, the method comprising:
generating an animation for an animatronic based on one or more creative requirements, the animation imitating one or more input motions and limited by the one or more creative requirements;
retargeting the animation onto the animatronic based on mechanical constraints of the animatronic, such that the animation is physically feasible on the animatronic; and
outputting the animation to the animatronic.

2. The method of claim 1, further comprising receiving animation source content for the animation, wherein the animation source content defines the one or more input motions.

3. The method of claim 1, wherein the generating comprises generating the animation using a trained model.

4. The method of claim 3, wherein the trained model is based on imitation learning or generative artificial intelligence.

5. The method of claim 1, wherein the one or more creative requirements comprise a music timing requirement, a facial requirement, or an artistic requirement.

6. The method of claim 1, wherein the mechanical constraints comprise physical limitations of the animatronic itself.

7. A system configured to perform the method of claim 1, wherein the system comprises the animatronic.

8. The system of claim 7, wherein the method is performed on the animatronic in real-time.

9. A method for animatronic animation generation, the method comprising:
receiving animation source content;
generating an animation for an animatronic based on the animation source content and based on at least one first constraint or requirement;
retargeting the animation onto the animatronic based on at least one second constraint or requirement; and
outputting the animation to the animatronic.

10. The method of claim 9, wherein the receiving comprises receiving a motion capture dataset of one more motions performed by an actor.

11. The method of claim 9, wherein the receiving comprises receiving existing animation performed by the animatronic or another animatronic.

12. The method of claim 9, wherein:
the animation is generated to imitate or match the animation source content irrespective of kinematic constraints of the animatronic; and
the retargeting comprises determining motions of the animatronic based on the kinematic constraints.

13. The method of claim 9, wherein the animation is a first animation, further comprising:
generating a second animation for the animatronic based on the animation source content and based on the at least one first constraint or requirement, wherein the second animation is different than the first animation; and
retargeting the second animation onto the animatronic based on the at least one second constraint or requirement.

14. The method of claim 9, wherein the at least one first constraint or requirement comprises a creative requirement defined by existing music, lighting, or narration.

15. The method of claim 9, wherein the at least one second constraint or requirement comprises a kinematic constraint of the animatronic.

16. A method for generating new animations for an animatronic, the method comprising:
receiving animation source content defining input motions;
generating an animation similar to the input motions and based on at least one creative requirement for the animation;
retargeting the animation onto the animatronic based on at least one kinematic or dynamic constraint of the animatronic; and
deploying the animation to the animatronic for performance by the animatronic.

17. The method of claim 16, wherein the retargeting comprises transferring the animation onto the animatronic using an inverse kinematics and/or inverse dynamics tool.

18. The method of claim 17, wherein the inverse kinematics and/or inverse dynamics tool validates the animation against all physical constraints of the animatronic.

19. The method of claim 16, further comprising receiving an operator command approving the animation.

20. The method of claim 16, wherein the input motions are created by a human or robot actor.

21. A method for training a model used to generate animations for an animatronic, the method comprising:
receiving a set of constraints of an animatronic and a set of motion data; and
training a model based on the set of motion data and the set of constraints to generate an animation that is physically feasible on an animatronic.

22. The method of claim 21, wherein:
the motion data comprises a set of input motions that is performed or has been previously performed by an actor; and
the training comprises:
analyzing kinematic inputs of the input motions,
simulating, based on the analysis, kinematic and dynamic motion of the animatronic, and
determining whether the kinematic and dynamic motion is feasible on the animatronic, wherein feasibility is defined as being within the set of constraints.

23. The method of claim 22, wherein the training further comprises repeating the simulation with one or more adjustments to the kinematic or dynamic motion based on the determination.

24. The method of claim 22, wherein the actor is a human actor, the animatronic, or a second animatronic.

25. The method of claim 21, wherein the training comprises learning an encoder and a decoder for the set of motion data.

26. The method of claim 21, wherein the set of constraints comprises at least one of a kinematic constraint, a dynamic constraint or a creative requirement.
